(19) United States
(12) Patent Application Publication
(10) Pub. No.: US 2002/0164068 A1
(43) Pub. Date: Nov. 7, 2002

(54) Model switching in a communication system

(75) Inventor: Yong Yan, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/848,062

(22) Filed: May 3, 2001

(51) Int. Cl. G06K 9/00

(52) U.S. Cl. 382/154

(57) ABSTRACT

A method and model-based communication system are disclosed that determine whether a specific model to more accurately represent a particular object is available so that the complexity of a model adaptation process during a communication secession can be reduced. A generic model can be initially used to start the communication sequence. Once an object has been identified by pattern recognition methods, an adapted model, if available, is switched/used for the mode-based coding. If the adapted model is not available, a generic model may be customized and later switched for the generic model.

### FIELD OF THE INVENTION

The present invention pertains generally to the field of video communications, and in particular, the invention relates to a system and method for switching models used in video communication systems to improve performance.

### BACKGROUND OF THE INVENTION

Video/image communication applications over very low bitrate channels such as the Internet or the Public Switch Telephone Network (PSTN) are growing in popularity and use. Conventional image communication technology, e.g., JPEG or GIF format, require a large bandwidth because of the size (i.e., amount of data) of the picture. Thus, in the low bitrate channel case, the received resulting image quality is generally not acceptable.

Methods have been used to improve video/image communication and/or to reduce the amount of information required to be transmitted for low bitrate channels. One such method has been used in videophone applications. An image is encoded by three sets of parameters which define its motion, shape and surface color. Since the subject of the visual communication is typically a human, primary focus can be directed to the subject's head or face.

One known method for object (face) segmentation is to create a dataset describing a parameterized face. This dataset defines a three-dimensional description of a face object. The parameterized face is given as an anatomically-based structure by modeling muscle and skin actuators and force-based deformations.

As shown in FIG. 1, a set of polygons define a human face model 100. Each of the vertices of the polygons are defined by X, Y and Z coordinates. Each vertex is identified by an index number. A particular polygon is defined by a set of indices surrounding the polygon. A code may also be added to the set of indices to define a color for the particular polygon.

Systems and methods are also known that analyze digital images, recognize a human face and extract facial features. Conventional facial feature detection systems use methods such as facial color tone detection, template matching or edge detection approaches.

In conventional face model-based video communications, a generic face model is typically either transmitted from the sender to the receiver at the beginning of a communication sequence or pre-stored at the receiver side. During the communication, the generic model is adapted to a particular speaker's face. Instead of sending entire images from the sender's side, only parameters that modify the generic face model need to be sent to achieve compression requirements. However, the generic model can not always satisfactorily represent an individual's appearance and still meet the compression requirement. For example, the parameters may not be able to adequately represent features such as long hair or eyeglasses even when sophisticated model adaptation techniques are applied.

There thus exists in the art a need for improved systems and methods for using models of objects contained in a digital image for improved video communication.

### BRIEF SUMMARY OF THE INVENTION

It is an object of the present invention to address the limitations of the conventional video/image communication systems and model-based coding discussed above.

It is another object of the invention to provide an object-oriented, cross-platform method of delivering real-time compressed video information.

It is yet another object of the invention to enable coding of specific objects within an image frame.

One aspect of the present invention is directed to using a specific model to more accurately represent a particular object so that the complexity of the model adaptation process during a video communication can be reduced. For example, in a face model-based video communication system, a generic model can be initially used to start the communication sequence. Once a speaker has been identified by pattern recognition methods, e.g., face recognition, the face model is switched to the speaker's model. This can be done either by re-transmitting from the sender side or reloading from a pre-stored model database at the receiver side. This aspect of the invention allows for communications involving multiple people, e.g., video teleconferencing, where the face model is switched between different speakers.

An other aspect of the present invention is directed to a process of creating and storing a database of face models for individuals.

One embodiment of the invention relates to a method for a model-based communication system including the steps of identify at least one object with in an image, extracting feature position information of the object and determining whether an adapted model is available based upon the extracted feature position information. If available, the adapted model is used in the model-based communication system.

These and other embodiments and aspects of the present invention are exemplified in the following detailed disclosure.

### BRIEF DESCRIPTION OF DRAWINGS

The features and advantages of the present invention can be understood by reference to the detailed description of the preferred embodiments set forth below taken with the drawings, in which:

FIG. 1 is a schematic front view of a human face model used for three-dimensional model-based coding.

FIG. 2 is a video communication system in accordance with a preferred embodiment of the present invention.

FIG. 3 is a block diagram of a Modeling/Database system in accordance with one aspect of the present invention.

FIG. 4 is a block diagram showing the architecture of the Modeling/Database system of FIG. 3.

FIG. 5 is a flow diagram in accordance with a preferred embodiment of the invention.

### DESCRIPTION OF THE PREFERRED EMBODIMENTS

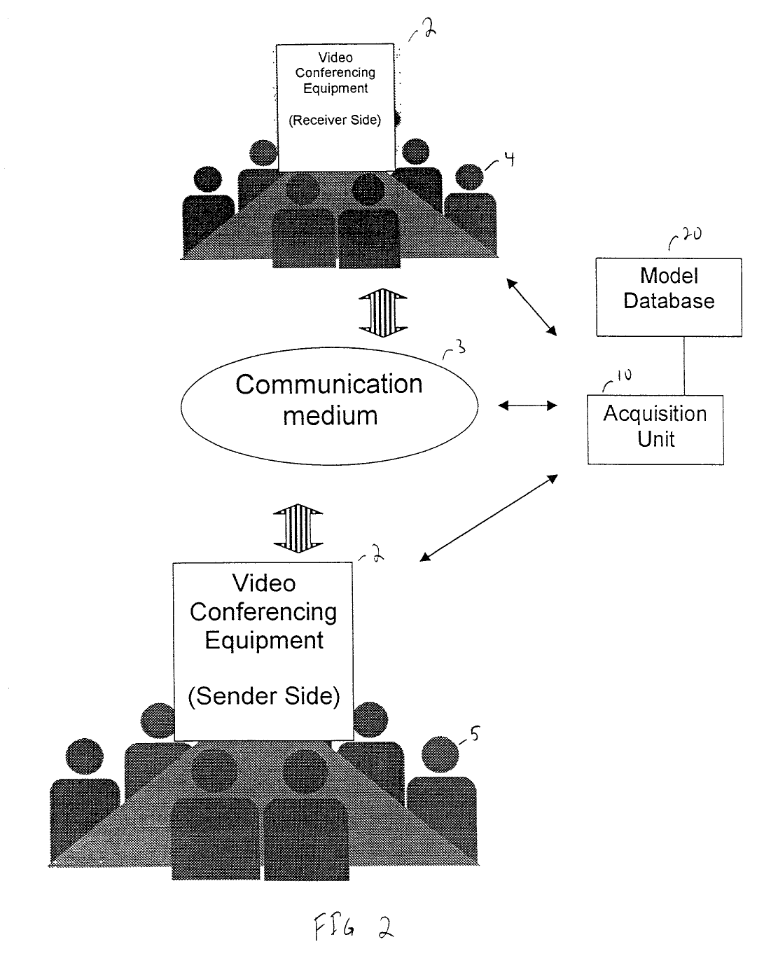

Referring now to FIG. 2, an exemplary video communication system 1, e.g., a video teleconferencing system, is shown. The system 1 includes video equipment, e.g., video conferencing equipment 2 (sender and receiver sides) and a communication medium 3. The system 1 also includes an acquisition unit 10 and a model database 20. While, the acquisition unit 10 and the model database 20 as shown as separate elements, it should be understood that these elements may be integrated with the video conferencing equipment 2.

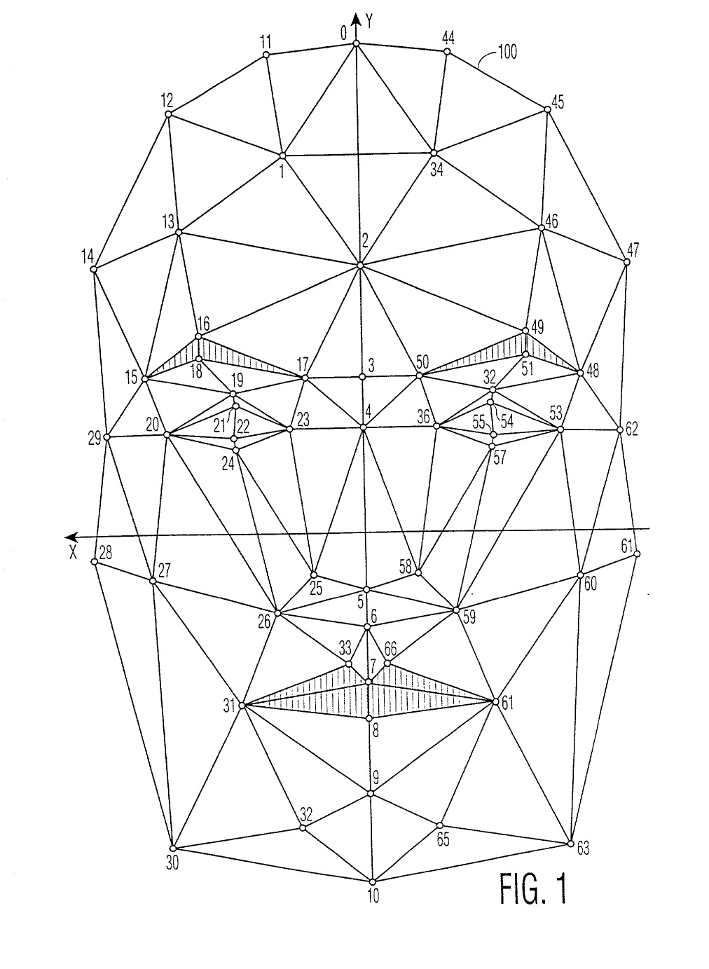

The acquisition unit 10 identifies various objects in the view of the video conferencing equipment 2 that may be modeled. In the embodiment shown in FIG. 2, an individuals face 4 or 5 may be represented as a model, e.g., as shown in FIG. 1. There may be a plurality of such objects that may be modeled with the view.

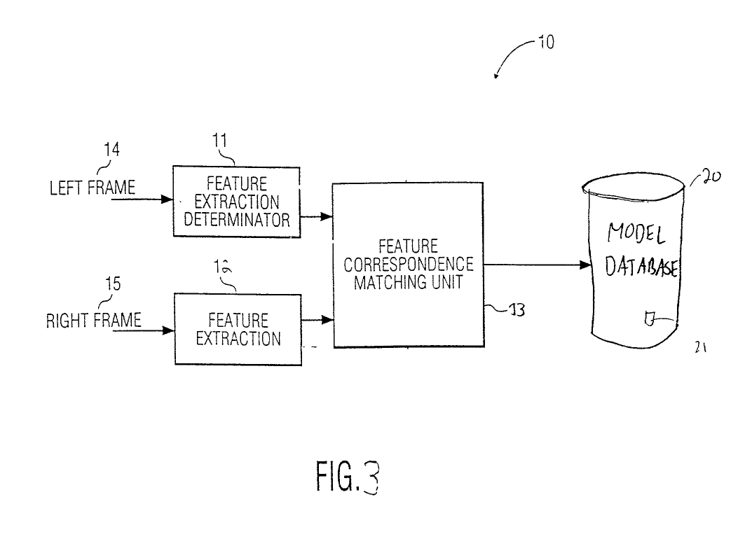

FIG. 3 shows a block diagram of the acquisition unit 10. The acquisition unit 10 includes one or more feature extraction determinators 11 and 12, and a feature correspondence matching unit 13. In this arrangement, a left frame 14 and a right frame are input into the acquisition unit 10. The left and right frames are comprised of image data which may be digital or analog. If the image data is analog than an analog-to-digital circuit can be used to convert the data to a digital format.

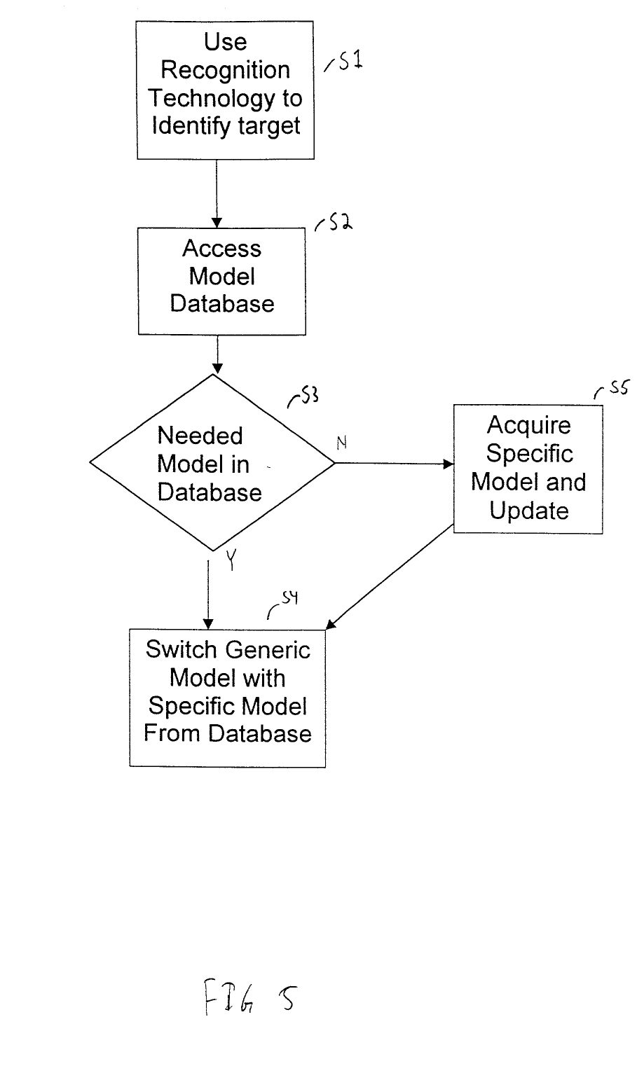

The feature extraction determinator 11 determines the position/location of features in a digital image such as facial feature positions of the nose, eyes, mouth, hair and other details (step S1 in FIG. 5). While two feature extraction determinators 11 and 12 are shown in FIG. 3, one determinator may be used to extract the position information from both the left and right frames 14 and 15. This information is then provided to the model database 20 (step S2 in FIG. 5). Preferably, the systems and methods described in U.S. patent application Ser. No. 08/385,280, filed on Aug. 30, 1999, incorporated by reference herein, comprise the feature extraction determinator 11.

A plurality of adapted models 21 may be stored in the model database 20. The adapted models 21 are customized or tailored to more accurately represent a specific object such as an individuals face. The model database 20 may also contain a plurality of generic models, e.g., as shown in FIG. 100.

Based upon the information from the acquisition unit 10, a search (step S3 in FIG. 5) is then performed to determine whether a match can be found for the object, e.g., face, being processed by the acquisition unit 10. Conventional image matching techniques may be used to perform this operation. If a match is found the adapted model 21 is switched, i.e., used for model-based coding, in the video communication system 1 (step S4 in FIG. 5). If a match is not found, then the generic face model 100 of FIG. 1 can be initialized. The generic face model 100 can then be adapted to a particular individual during the video communication session adapted based upon information from the acquisition unit 10 (step S5 in FIG. 5). When the adaptation is complete, the newly acquired adapted model 21 may be switched for use in place of the generic face model 100. This newly adapted model 21 may also be stored in the model database 20 for future use.

Additional details of generic model adaptation are described in U.S. patent application Ser. No. 09/422,735, filed on Oct. 21, 1999, incorporated by reference herein.

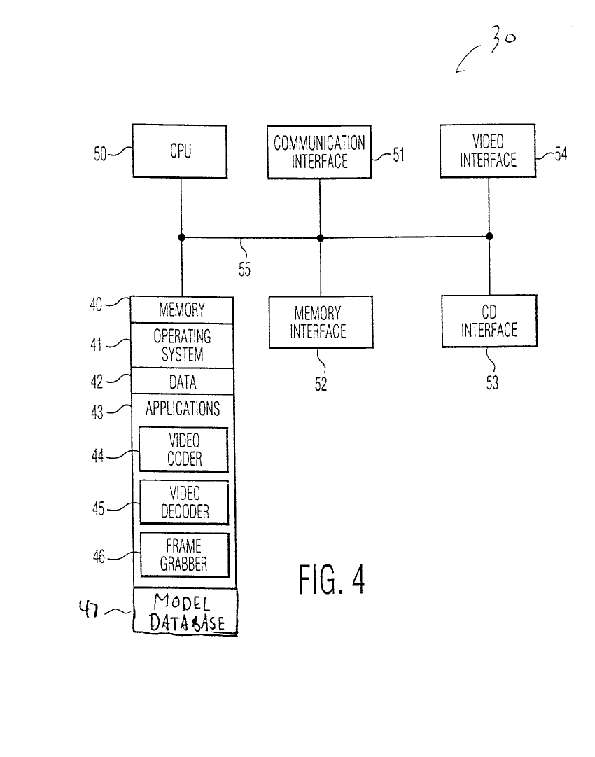

In a preferred embodiment, the model switching functions of the system 1 are implemented by computer readable code executed by a data processing apparatus. The code may be stored in a memory within the data processing apparatus or read/downloaded from a memory medium such as a CD-ROM or floppy disk. In other embodiments, hardware circuitry may be used in place of, or in combination with, software instructions to implement the invention. These functions/software/hardware may be formed as part of the video conference equipment 2 or be an adjunct unit. The invention, for example, can also be implemented on a computer 30 shown in FIG. 4.

The computer 30 may include a network connection for interfacing to a data network, such as a variable-bandwidth network or the Internet, and a fax/modem connection 32 for interfacing with other remote sources such as a video or a digital camera (not shown). The computer 30 may also include a display for displaying information (including video data) to a user, a keyboard for inputting text and user commands, a mouse for positioning a cursor on the display and for inputting user commands, a disk drive for reading from and writing to floppy disks installed therein, and a CD-ROM drive for accessing information stored on CD-ROM. The computer 30 may also have one or more peripheral devices attached thereto, such as a pair of video conference cameras for inputting images, or the like, and a printer for outputting images, text, or the like.

FIG. 4 shows the internal structure of the computer 30 which includes a memory 40 that may include a Random Access Memory (RAM), Read-Only Memory (ROM) and a computer-readable medium such as a hard disk. The items stored in the memory 40 include an operating system 41, data 42 and applications 43. In preferred embodiments of the invention, the operating system 41 is a windowing operating system, such as UNIX; although the invention may be used with other operating systems as well such as Microsoft Windows 95. Among the applications stored in memory 40 are a video coder 44, a video decoder 45 and a frame grabber 46. The video coder 44 encodes video data in a conventional manner, and the video decoder 45 decodes video data which has been coded in the conventional manner. The frame grabber 46 allows single frames from a video signal stream to be captured and processed.

Also included in the computer 30 are a central processing unit (CPU) 50, a communication interface 51, a memory interface 52, a CD-ROM drive interface 53, a video interface 54 and a bus 55 The CPU 50 comprises a microprocessor or the like for executing computer readable code, i.e., applications, such those noted above, out of the memory 50. Such applications may be stored in memory 40 (as noted above) or, alternatively, on a floppy disk in disk drive 36 or a CD-ROM in CD-ROM drive 37. The CPU 50 accesses the applications (or other data) stored on a floppy disk via the memory interface 52 and accesses the applications (or other data) stored on a CD-ROM via CD-ROM drive interface 53.

Input video data may be received through the video interface 54 or the communication interface 51. The input video data may be decoded by the video decoder 45. Output video data may be coded by the video coder 44 for transmission through the video interface 54 or the communication interface 51.

During a video communication session, once the adapted model 21 is switched for the object, information and processing performed by the feature correspondence matching unit 13 and the feature extraction determinator 11 is used to adapt the adjusted model to enable movement, expressions and synchronize audio (i.e., speech). Essentially, the adapted model 21 is dynamically transformed to represent the object as needed during the video communication session. The real-time or non-real-time transmission of the model parameters/data provides for low bit-rate animation of a synthetic model. Preferably, the data rate is 64 Kbit/sec or less, however, for moving image a data rate between 64 Kbit/sec to 4 Mbit/sec is also acceptable.

By using the adapted models 21 to represent a particular object, the result looks more realistic and the complexity of the dynamic model adaptation is reduced.

The invention has numerous applications in fields such as video conferencing and animation/simulation of real objects, or in any application in which object modeling is required. For example, typical applications include video games, multimedia creation and improved navigation over the Internet.

In addition, the invention is not limited to face models. The invention may be used with adapted models 21 of other physical objects and scenes; such as 3D models of automobiles and rooms. In this embodiment the feature extraction determinator 11 gathers position information related to the particular object or scene in questions, e.g., the position of wheels or the location furniture. Further processing of the adapted model 21 is then based on this information.

While the present invention has been described above in terms of specific embodiments, it is to be understood that the invention is not intended to be confined or limited to the embodiments disclosed herein. For example, the invention is not limited to any specific type of filtering or mathematical transformation or to any particular input image scale or orientation. On the contrary, the present invention is intended to cover various structures and modifications thereof included within the spirit and scope of the appended claims.

What is claimed is:

1. A method for a model-based communication system comprising the steps of:
identify at least one object with in an image;
extracting feature position information of the object;
determining whether an adapted model is available based upon the extracted feature position information; and
if available, using the adapted model in the model-based communication system.

2. The method according to claim 1, further comprising the step of acquiring a customized model related to the object by modifying a generic model of the object.

3. The method according to claim 2, further comprising the step of storing the customized model and using the customized model in the model-based communication system.

4. The method according to claim 3, further comprising the step of initializing a generic model and using the generic model in the model-based communication system until the customized model is available.

5. The method according to claim 1, wherein the model-based communication system comprises a video teleconferencing system.

6. The method according to claim 1, wherein the adapted model is a human face model.

7. The method according to claim 1, wherein the adapted model is a 3D representation.

8. A model-based communication apparatus comprising:
means for identify at least one object with in an image;
means for extracting feature position information of the object;
means for determining whether an adapted model is available based upon the extracted feature position information; and
means for communicating information using the adapted model, if available.

9. The apparatus according to claim 8, further comprising means for acquiring a customized model related to the object by modifying a generic model of the object.

10. The apparatus according to claim 9, further comprising a memory capable of storing the customized model, and
wherein the means for communicating uses the customized model.

11. The apparatus according to claim 10, further comprising means for initializing/using a generic model until the customized model is available.

12. The apparatus according to claim 8, wherein the model-based communication apparatus comprises a video teleconferencing system.

13. The image processing device according to claim 8 wherein the adapted model is a human face model.

14. A computer-readable memory medium including code for a model-based communication apparatus, the code comprising:
code to identify at least one object with in an image;
code to extract feature position information of the object;
code to determine whether an adapted model is available based upon the extracted feature position information; and
code to use, if available, the adapted model in the model-based communication system.

15. The memory medium according to claim 14, further comprising code to acquire a customized model related to the object by modifying a generic model of the object.

16. The memory medium according to claim 15, further comprising code to store the customized model and use the customized model in the model-based communication system.

17. The memory medium according to claim 16, further comprising code to initialize a generic model and use the generic model in the model-based communication system until the customized model is available.

18. The memory medium according to claim 14, wherein the model-based communication system comprises a video teleconferencing system.

19. The memory medium according to claim 14, wherein the adapted model is a human face model.

20. The memory medium according to claim 14, wherein the adapted model is a b 3D representation.
